(19) United States
(12) Patent Application Publication
(10) Pub. No.: US 2012/0097058 A1
(43) Pub. Date: Apr. 26, 2012

(54) Multiplexed Biomolecule Arrays Made By Polymer Pen Lithography

(75) Inventors: Chad A. Mirkin, Wilmette, IL (US); Fengwei Huo, Nanyang Heights (SG); Zijian Zheng, Hong Kong (CN); Louise R. Giam, Potomac, MD (US); Weston L. Daniel, Evanston, IL (US)

(73) Assignee: NORTHWESTERN UNIVERSITY, Evanston, IL (US)

(21) Appl. No.: 13/263,760

(22) PCT Filed: Apr. 23, 2010
(86) PCT No.: PCT/US10/32244

§ 371 Date: Dec. 20, 2011

Related U.S. Application Data
(62) Division of application No. 61/172,481, filed on Apr. 24, 2009.

(51) Int. Cl. B41F 33/00; B42D 15/00

(52) U.S. Cl. 101/483; 283/74

(57) ABSTRACT

Methods of patterning multiple biomolecules on a surface are disclosed. The method includes inking a polymer pen array, where tips are inked with selected inks comprising the biomolecules, and transferring the biomolecules to a surface using a polymer pen lithography technique. Methods of using the multiple patterned biomolecules on a surface are also disclosed.

### CROSS REFERENCE TO RELATED APPLICATIONS

This application claims the benefit of U.S. Provisional Application No. 61/172,481, filed Apr. 24, 2009, the entirety of which is incorporated by reference.

### STATEMENT OF U.S. GOVERNMENTAL INTEREST

This invention was made with U.S. government support under National Science Foundation Grant No. EEC-0647560, DARPA Grant No. N66001-08-102044, and National Institutes of Health (NIH)/National Cancer Institute/Centers of Cancer Nanotechnology Excellence (NCI/CCNE) Grant Number 1U54CA119341. The government has certain rights in this invention.

### BACKGROUND

The ability to fabricate biomolecule (e.g., protein) micro and nano arrays in a low-cost and high throughput manner is important for a wide variety of applications, including drug screening, medical diagnostics, biosensors, and fundamental biological studies. (1-3) Traditional approaches to making such microarrays include photolithography and inkjet printing. Recently, studies have focused on the miniaturization of protein patterns into the nanometer regime because high density protein nanoarrays provide increased detection sensitivity and allow one to screen millions of biomarkers in one chip. (4) Protein nanopatterns can also lead to insights for fundamental biological processes, (5) such as cell adhesion. (6,7) Among the many new techniques aimed towards size miniaturization of protein structures, including microcontact printing, (8,9) nanoimprint lithography, (10) and certain scanning probe lithographies, and the like, (4,11,12) dip-pen nanolithography (DPN) (13) is the only “direct write” method which allows one to generate bioactive protein patterns of extraordinary complexity at the nanoscale. (14,15) Lee et al. (7,16) first showed that one can use an atomic force microscopy (AFM) cantilever to generate nanoarrays of one protein (or two different proteins in two sequential steps) on a surface by DPN. The throughput of this serial writing process can be increased with the use of one-dimensional (1D) (17,18) and two-dimensional (2D) (19,20) parallel cantilever arrays or with a flat stamp method. (21) Importantly, the “direct write” character of DPN minimizes ink cross contamination.

Patterning different kinds of proteins by DPN over large areas remains a challenge for several reasons. First, the opacity of Si and Si₃N₄ cantilevers makes it difficult, if not impossible, to align a 2D cantilever array for inking multiple proteins using inkwells. Second, the diffusion rates for different proteins can vary because of differences in their molecular weights, hydrodynamic radii, and other factors. Such variation may lead to non-uniform feature sizes among different proteins even though the tip-substrate contact time is held constant. Third, because the diffusion rates of proteins are typically low, the fabrication of sub-micron or micron scale protein patterns useful for optical detection purposes is a time-consuming process. Fourth, the 2D Si₃N₄ cantilever array required for large scale parallel DPN experiments is costly and fragile. Thus, a need exists for methods that provide patterned deposition of multiple biomolecules over a large area in a reproducible manner.

### SUMMARY

The present disclosure is directed to methods of printing biomolecules on a substrate surface using a polymer tip array. More specifically, disclosed herein are methods of printing multiple biomolecules on a substrate surface using a tip array comprising a compressible polymer comprising a plurality of non-cantilevered tips each having a radius of curvature of less than about 1 μm, and forming indicia of two or more biomolecules in parallel.

Thus, in one aspect, provided herein is a method of simultaneously printing at least two different biomolecules on a substrate surface comprising coating a tip array with at least two inks by dipping the tip array into a corresponding inkwell array having a first plurality of wells comprising a first ink comprising a first biomolecule and a first carrier and a second plurality of wells comprising a second ink comprising a second biomolecule and a second carrier such that a first plurality of tips of the tip array are dipped into the first plurality of wells and coated with the first ink and the second plurality of tips of the tip array are dipped into the second plurality of wells and coated with the second ink, the tips of the tip array comprising non-cantilevered tips each having a radius of curvature of less than about 1 μm and comprising a compressible elastomeric polymer; contacting a substrate surface for a first contacting period of time and at a first contacting pressure with all or substantially all of the coated tips of the array to deposit the first ink onto the substrate surface at a set of first positions to form a first set of indicia and the second ink onto the substrate surface at a set of second positions to form a second set of indicia, the all of the indicia of the first and second sets being substantially uniform in size.

In various embodiments, the tip array further comprises a third plurality of tips and the inkwell array comprises a third plurality of wells comprising a third ink comprising a third biomolecule and a third carrier, and further comprising coating the third plurality of tips during said dipping step and printing the third biomolecule on the substrate surface during said contacting step, to form a third set of indicia at a set of third positions, wherein all of the indicia of the third set are substantially uniform in size with the first set of indicia and the second set of indicia. In some specific embodiments, all of the indicia of the third set are substantially uniform in biomolecule density with the first set of indicia or the second set of indicia. All of the indicia of the third set can be substantially uniform in biomolecule density with the first set of indicia and the second set of indicia.

In some cases, each tip of the tip array is simultaneously contacted with the substrate surface.

In some cases, the indicia are also substantially uniform in ink density. In various cases, each tip has a radius of curvature of less than about 0.2 μm. Each tip can be identically shaped, such as pyramidal. Each well can be identically shaped, such as pyramidal. The compressible elastomeric polymer of the tip array has a compression modulus in a range of about 10 MPa to about 300 MPa. In some cases, the compressible elastomeric polymer comprises polydimethylsiloxane (PMDS), and in specific cases, the PMDS comprises a trimethylsiloxy terminated vinylmethylsiloxane-dimethysiloxane copolymer, a methylhydrosiloxane-dimethylsiloxane copolymer, or a mixture thereof.

In some embodiments, the inkwell has inter-well spacings, well dimensions, or both, which correspond to tip apex spacings, tip dimensions, or both, of the tips of the tip array, respectively. In some specific cases, at least one apex of a tip of the first plurality of tips and at least one apex of a tip of the second plurality of tips are separated by a distance of less than 200 μm, or less than 100 μm. In various cases, the method comprises coating the tip array with no or substantially no contamination of the first ink to the second plurality of tips. In some cases, the method comprises forming the first set of indicia with no or substantially no contamination of the second ink. In various cases, the method comprises forming the first set of indicia, the second set of indicia, or both with a feature size of less than 1 μm.

In various embodiments, the methods disclosed herein further comprise at least partially filling the first plurality of wells with the first ink and at least partially filling the second plurality of wells with the second ink by jetting droplets of ink into the wells using an inkjet printer. In some cases, the inkjet printer is an electrohydrodynamic inkjet printer. In various cases, at least the well side of the inkwell array comprises a fluorinated surface. In some specific cases, the fluorinated surface comprises a fluorinated silane. The fluorinated silane can comprise 1H,1H,2H,2H-perfluorodecyltrichlorsilane.

The biomolecules can comprise an antibody, antigen, protein, enzyme, peptide, oligonucleotide, polynucleotide, oligosaccharide, polysaccharide, or mixture thereof. The first ink, the second ink, or each of the first ink and second ink can comprise glycerol, polyethylene glycol, or a mixture thereof. In some cases, the first biomolecule, the second biomolecule, or both further comprise a label. In various cases, the first and second biomolecule each comprise a different label. The label can be a fluorescent label. The fluorescent label can be selected from the group consisting of a fluorescein dye, 6-((7-amino-4-methylcoumarin-3-acetyl)amino)hexanoic acid, 5(and 6)-carboxy-X-rhodamine, a rhodamine dye, a benzophenoxazine, Cyanine 2 (Cy2) dye, Cyanine 3 (Cy3) dye, Cyanine 3.5 (Cy3.5) dye, Cyanine 5 (Cy5) dye, Cyanine 5.5 (Cy5.5) dye, Cyanine 7 (Cy7) dye, Cyanine 9 (Cy9) dye, 6-carboxy-4′,5′-dichloro-2′,7′-dimethoxyfluorescein, 5(6)-carboxy-tetramethyl rhodamine, and combinations thereof.

In some embodiments, the method further comprises moving the tip array, the substrate surface, or both, with respect to each other, and repeating the contacting step for a second contacting period of time, same or different from the first contacting period of time and at a second contacting pressure, same or different from the first contacting pressure. In some cases, the method comprises limiting lateral movement between the tip array and the substrate during the contacting step, to form indicia comprising dots. In some specific embodiments, the method comprises controlling the contacting period of time, the contacting pressure, or both to form the dots with a diameter in a range of about 10 nm to about 500 μm.

In various embodiments, the methods disclosed herein further comprise leveling the tips of the tip array with respect to the substrate surface by backlighting the tip array with incident light to cause internal reflection of the incident light from the internal surfaces of the tips; bringing the tips of the tip array and the substrate surface together along a z-axis up to a point of contact between a subset of the tips with the substrate surface, contact indicated by increased intensity of reflected light from the subset of tips in contact with the substrate surface, whereas no change in the intensity of reflected light from other tips indicates non-contacting tips; and tilting one or both of the tip array and the substrate surface with respect to the other in response to differences in intensity of the reflected light from the internal surfaces of the tips, to achieve contact between the substrate surface and non-contacting tips, wherein said tilting is performed one or more times along x-, y-, and/or z-axes.

In some embodiments, the methods disclosed herein further comprise leveling the tips of the tip array with respect to the substrate surface by backlighting the tip array with incident light to cause internal reflection of the incident light from the internal surfaces of the tips; bringing the tips of the tip array and the substrate surface together along a z-axis to cause contact between the tips of the tip array and the substrate surface; further moving one or both of the tip array and the substrate towards the other along the z-axis to compress a subset of the tips, whereby the intensity of the reflected light from the tips increases as a function of the degree of compression of the tips against the substrate surface; and tilting one or both of the tip array and the substrate surface with respect to the other in response to differences in intensity of the reflected light from internal surfaces of the tips, to achieve substantially uniform contact between the substrate surface and tips, wherein said tilting is performed one or more times along x-, y- and/or z-axes.

In various embodiments, the method further comprises forming a master comprising an array of recesses in a substrate separated by lands; filling the recesses and covering the lands with a prepolymer mixture comprising an prepolymer and, optionally, a crosslinker; covering the filled and coated substrate with a planar glass layer; curing the prepolymer mixture to form a polymer structure that comprises the tip array and common substrate; removing the cured polymer structure from the master; and at least partially filling the recesses of the master with one or more inks for use as an inkwell array for the tip array. The surface of the master can be treated with a fluorinated substance, such as a fluorinated silane (e.g., 1H,1H,2H,2H-perfluorodecyltrichlorsilane). This treatment can occur before or after filing the master with the prepolymer mixture.

In some embodiments, the method further comprises fabricating a mold having recesses and lands; forming a tip array with the mold; removing the formed tip array from the mold; at least partially filling the recesses of the mold with one or more inks to form an inkwell array; and then coating a tip array with said inks by dipping the tip array into the inkwell array. The surface of the master can be treated with a fluorinated substance, such as a fluorinated silane (e.g., 1H,1H,2H,2H-perfluorodecyltrichlorsilane). This treatment can occur before or after filing the master with the prepolymer mixture.

In another aspect, provided herein is an article comprising a substrate; a first set of indicia on the substrate surface comprising a first biomolecule, and a second set of indicia on the substrate surface comprising a second biomolecule, wherein all of the indicia of the first set and the second set are substantially uniform in size and an indicium of the first set and an indicium of the second set are separated on the surface by a distance of less than 200 μm. In some cases, all of the indicia of the first set and the second set are substantially uniform in density. In various cases, an indicium of the first set and an indicium of the second set are separated on the surface by a distance of less than 100 μm. In some cases, all of the indicia of the first and second sets have a feature size of less than 100 μm. In various embodiments, the first biomolecule, the second biomolecule, or each of the first biomolecule and the second biomolecule comprises an antibody, antigen, protein, enzyme, peptide, oligonucleotide, polynucleotide, oligosaccharide, polysaccharide, or mixture thereof. In some cases, the article further comprises a third set of indicia on the substrate surface comprising a third biomolecule, wherein all of the indicia of the third and all of the indicia of the first set are substantially uniform in size. In some specific cases, all of the indicia of the third set and all of the indicia of the first set are substantially uniform in density.

### BRIEF DESCRIPTION OF THE FIGURES

FIG. 1 shows (A) a schematic illustration of the process of patterning multiplexed protein arrays by PPL; fluorescent images of (B) Si inkwells inked with 3 proteins by inkjet printing; (C) a polymer pen array dipped into the Si inkwells in (B); (D) multiplexed protein arrays made by PPL with the polymer pen array in (C) (row 1: Alex Fluor 647 conjugated anti-cholera toxin beta (CTβ); row 2: TRITC conjugated anti-mouse IgG; row 3: Alex Fluor 488 conjugated anti-prostate specific antigen (PSA)).

FIG. 2 shows (A) a tapping mode AFM-produced topography image of CTβ/glycerol patterned on a Codelink slide by PPL; (B) a zoom in AFM topography of (A); (C) feature size of patterned protein arrays as a function of tip-substrate contact force; and (D) fluorescent image of PSA arrays labeled with Alex Fluor 488 conjugated anti-PSA at different tip-substrate contact times and contact forces, wherein the inset is a zoom-in image.

FIG. 3 shows the relationship between tip contact time (s) and feature size of the resulting indicia in one embodiment.

FIG. 4 shows a schematic illustration of one embodiment of a set up of tip array, piezo scanner, and substrate surface, in relation to a light source, used for leveling the tip array with respect to the substrate surface, and further indicates where the tip apex of a tip on a tip array is located.

FIG. 5A shows the relationship of the dot sizes with tip-substrate contact time of selected ink materials, wherein the slopes of the plots reflect the corresponding ink's diffusion constant.

FIG. 5B shows that the ink diffusion rates of IgG and β-galactosidase can be tuned to be very close to one another, across a range of tip-substrate contact times, at ink/PEG ratios of 1:5 and 1:7.5, respectively.

### DETAILED DESCRIPTION

Disclosed herein are methods of patterning arrays of proteins and other biomolecules, and methods of using patterned arrays of proteins and other biomolecules in, for example, various detection assays.

Recently, polymer pen lithography (PPL), a single lithographic tool that enables one to direct-write nano and micro structures of molecule-based materials, has been reported. See reference 23 and WO 09/132,321, incorporated by reference in its entirety herein. Instead of hard Si₃N₄ cantilevers, PPL uses a soft polymer pen array composed of many tips on a small surface area (e.g., as many as 11 million writing pens on a 3-inch (7.6 cm) diameter wafer area) to deliver inks onto a surface by controlling the movement of the pen array with a scanning probe microscope. Demonstrated herein are methods of using PPL to pattern multiplexed protein and other biomolecule arrays in one step with control of their nano and micro structures. Importantly, in various cases, the protein arrays generated by PPL maintain their bioactivity, as demonstrated by experiments indicating specific antigen-antibody recognition.

As used herein, the term “biomolecule” refers to any one or more of oligonucleotides, polynucleotides, antigens, antibodies, polypeptides, proteins, enzymes, oligosaccharides, polysaccharides, and the like.

In various aspects, the biomolecule can optionally further comprise a label. “Label” refers to any substance which is capable of producing a signal that is detectable by visual or instrumental means, such as labels which produce signals through either chemical or physical means. Such labels can include enzymes and substrates, chromogens, catalysts, fluorophores, chemiluminescent compounds, and radioactive labels.

In various cases, the label is covalently attached to the biomolecule. In some cases, the label is non-covalently attached to the biomolecule. The label can be attached to the biomolecule through a spacer. In various cases, the spacer comprises a polymer, such as a water soluble polymer. In some specific cases, the polymer comprises an oligonucleotide, an oligosaccharide, or a polyethylene glycol.

In some cases, the label comprises a fluorophore selected from the group consisting of a fluorescein dye, 6-((7-amino-4-methylcoumarin-3-acetyl)amino)hexanoic acid, 5(and 6)-carboxy-X-rhodamine, a rhodamine dye, a benzophenoxazine, Cyanine 2 (Cy2) dye, Cyanine 3 (Cy3) dye, Cyanine 3.5 (Cy3.5) dye, Cyanine 5 (Cy5) dye, Cyanine 5.5 (Cy5.5) dye, Cyanine 7 (Cy7) dye, Cyanine 9 (Cy9) dye, 6-carboxy-4′,5′-dichloro-2′,7′-dimethoxyfluorescein, 5(6)-carboxy-tetramethyl rhodamine, and combinations thereof. Radioisotopes include, but are not limited to, ³⁵S, ¹⁴C, ¹²⁵I, ³H, ¹³¹I, and combinations thereof.

Other suitable labels include particulate labels such as colloidal metallic particles such as gold, colloidal non-metallic particles such as selenium or tellurium, dyed or colored particles such as a dyed plastic or a stained microorganism, organic polymer latex particles and liposomes, colored beads, polymer microcapsules, sacs, erythrocytes, erythrocyte ghosts, or other vesicles containing directly visible substances, and the like. In some cases, a visually detectable label is used as the label component of the label reagent, thereby providing for the direct visual or instrumental readout of the presence or amount of the analyte in the test sample without the need for additional signal producing components at the detection sites.

The selection of a particular label is not critical to the present invention, but the label will be capable of generating a detectable signal either by itself, or be instrumentally detectable, or be detectable in conjunction with one or more additional signal producing components, such as an enzyme/substrate signal producing system. A variety of different label reagents can be formed by varying either the label or the specific binding member component of the label reagent; it will be appreciated by one skilled in the art that the choice involves consideration of the analyte to be detected and the desired means of detection.

For example, one or more signal producing components can be reacted with the label to generate a detectable signal. If the label is an enzyme, then amplification of the detectable signal is obtained by reacting the enzyme with one or more substrates or additional enzymes and substrates to produce a detectable reaction product.

The use of dyes for staining biological materials, such as proteins, carbohydrates, nucleic acids, and whole organisms is documented in the literature. It is known that certain dyes stain particular materials preferentially based on compatible chemistries of dye and ligand. For example, Coomassie Blue and Methylene Blue for proteins, periodic acid-Schiff reagent for carbohydrates, Crystal Violet, Safranin O, and Trypan Blue for whole cell stains, ethidium bromide and Acridine Orange for nucleic acid staining, and fluorescent stains such as rhodamine and Calcofluor White for detection by fluorescent microscopy. Further examples of labels can be found in, at least, U.S. Pat. Nos. 4,695,554; 4,863,875; 4,373,932; and 4,366,241, all incorporated herein by reference.

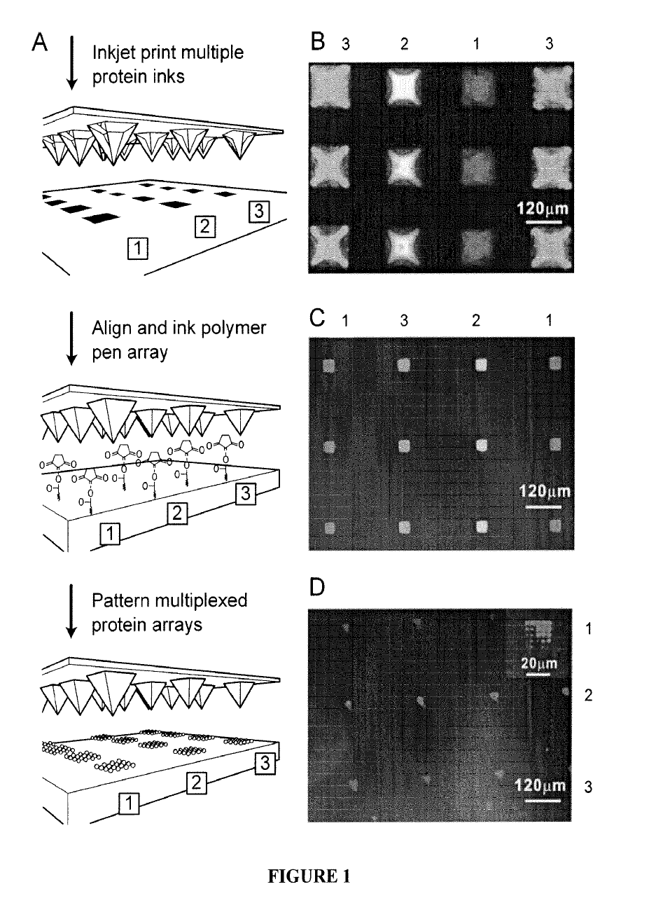

FIG. 1A shows a schematic representation of a method disclosed herein. In one type of experiment, inkwells with inter-well spacings and dimensions matching those of the polymer pen array are first filled with protein inks by inkjet printing. In some embodiments, a mold used to prepare the tip arrays is used as the inkwell. In such embodiments, the tips of the tip array align completely or substantially completely with the inter-well spacings, dimensions, or both of the wells of the inkwell. This mold inkwell can be seen in the following scheme, showing a cutaway side view of the inkwell. The indentations which initially created the mold for the polymer pen array tips can be filled with ink and used to selectively coated specific tips with corresponding inks.

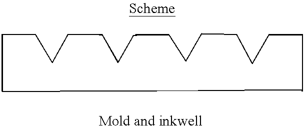

The inked tips can then be used to generate indicia on a substrate surface, whereby the spacing and placement of the indicia are controlled by the selectively inked tips and the contacting of the tips using PPL techniques.

Demonstrated herein is the use of PPL for the multiplexed patterning of biomolecule (e.g., protein) nano and micro arrays in a high throughput and low-cost manner. The pyramidal pens inked with inkwells showed good addressability and no cross contamination between neighboring pens. Protein and other biomolecule arrays can be readily made by a “direct write” method without cross-talk, while maintaining their bioactivity. This method is a general approach which can be applied to large scale, multiplexed patterning of biomolecules.

### Polymer Pen Lithography

A defining characteristic of Polymer Pen Lithography is that it exhibits both time- and pressure-dependent ink transport. As with DPN, features made by Polymer Pen Lithography exhibit a size that is linearly dependent on the square root of the tip-substrate contact time. This property of Polymer Pen Lithography, which is a result of the diffusive characteristics of the ink and the small size of the delivery tips, allows one to pattern sub-micron features with high precision and reproducibility (variation of feature size is less than 10% under the same experimental conditions). The pressure dependence of Polymer Pen Lithography derives from the compressible nature of the elastomer pyramid array. Indeed, the microscopic, preferably pyramidal, tips can be made to deform with successively increasing amounts of applied pressure, which can be controlled by simply extending a piezo in the vertical direction (z-piezo). Although such deformation has been regarded as a major drawback in contact printing (it can result in “roof” collapse and limit feature size resolution), with Polymer Pen Lithography, the controlled deformation can be used as an adjustable variable, allowing one to control tip-substrate contact area and resulting feature size. Within the pressure range allowed by z-piezo extension of about 5 to about 25 μm, one can observe a near linear relationship between piezo extension and feature size at a fixed contact time of 1 s. Interestingly, with PPL array embodiments which have employed a tip array on a backing elastomer layer, at the point of initial contact and up to a relative extension 0.5 μm, the sizes of the dots do not significantly differ and are both about 500 nm (in this specific instance), indicating that the backing elastomer layer, which connects all of the pyramids, deforms before the pyramid-shaped tips do. This type of buffering is fortuitous for leveling because it provides extra tolerance in bringing all of the tips in contact with the surface without tip deformation and significantly changing the intended feature size. When the z-piezo extends 1 μm or more, the tips exhibit a significant and controllable deformation.

With the pressure dependency of Polymer Pen Lithography, one does not have to rely on the time-consuming, meniscus-mediated ink diffusion process to generate large features. Indeed, one can generate nanometer- to micrometer-sized features in only one printing cycle by simply adjusting the degree of tip deformation. As proof-of-concept, 6×6 gold square arrays, wherein each square in a row was written with one printing cycle at different tip-substrate pressures but a constant 1 s tip-substrate contact time, were fabricated by Polymer Pen Lithography and subsequent wet chemical etching, and the largest and smallest gold squares produced were 4 μm and 600 nm on edge. Note that this experiment does not define the feature size range attainable in a Polymer Pen Lithography experiment, but rather, is a demonstration of the multiple scales accessible by Polymer Pen Lithography at a fixed tip-substrate contact time (1 s in this case).

Polymer Pen Lithography, unlike conventional contact printing, allows for the combinatorial patterning of molecule-based and solid-state features with dynamic control over feature size, spacing, and shape. This is accomplished by using the polymer tips to form a dot pattern of the structure one wants to make. Frequent re-inking of the pen array is not necessary with PDMS polymer tip arrays and compatible inks, because the PDMS polymer behaves as a reservoir for the ink throughout the patterning. This relatively high-throughput production of multiscale patterns would be difficult, if not impossible, to do by other lithographic techniques, such as electron beam lithography (EBL) or DPN.

Note that the maskless nature of Polymer Pen Lithography allows one to arbitrarily make many types of structures without the hurdle of designing a new master via a throughput-impeded serial process. In addition, Polymer Pen Lithography can be used with sub-100 nm resolution with the registration capabilities of a closed-loop scanner.

### Tip Arrays

The lithography methods disclosed herein employ a tip array formed from elastomeric polymer material. The tip arrays are non-cantilevered and comprise tips which can be designed to have any shape or spacing between them, as needed. The shape of each tip can be the same or different from other tips of the array. Contemplated tip shapes include spheroid, hemispheroid, toroid, polyhedron, cone, cylinder, and pyramid (e.g., trigonal or square). The tips are sharp, so that they are suitable for forming submicron patterns, e.g., less than about 500 nm. The sharpness of the tip is measured by its radius of curvature, and the radius of curvature of the tips preferred herein is below 1 μm, and can be less than about 0.9 μm, less than about 0.8 μm, less than about 0.7 μm, less than about 0.6 μm, less than about 0.5 μm, less than about 0.4 μm, less than about 0.3 μm, less than about 0.2 μm, less than about 0.1 μm, less than about 90 nm, less than about 80 nm, less than about 70 nm, less than about 60 nm, or less than about 50 nm, for example.

The tip array can be formed from a mold made using photolithography methods, which is then used to fashion the tip array using a polymer as disclosed herein. The mold can be engineered to contain as many tips arrayed in any fashion desired. The tips of the tip array can be any number desired, and contemplated numbers of tips include about 1000 tips to about 15 million tips, or greater. The number of tips of the tip array can be greater than about 1 million, greater than about 2 million, greater than about 3 million, greater than about 4 million, greater than 5 million tips, greater than 6 million, greater than 7 million, greater than 8 million, greater than 9 million, greater than 10 million, greater than 11 million, greater than 12 million, greater than 13 million, greater than 14 million, or greater than 15 million tips.

The tips of the tip array can be designed to have any desired thickness, but typically the thickness of the tip array (measured from the apex of the tip to the base of the tip) is about 50 nm to about 1 μm, about 50 nm to about 500 nm, about 50 nm to about 400 nm, about 50 nm to about 300 nm, about 50 nm to about 200 nm, or about 50 nm to about 100 nm.

The polymers can be any polymer having a compressibility compatible with the lithographic methods. Polymeric materials suitable for use in the tip array can have linear or branched backbones, and can be crosslinked or non-crosslinked, depending upon the particular polymer and the degree of compressibility desired for the tip. Cross-linkers refer to multi-functional monomers capable of forming two or more covalent bonds between polymer molecules. Non-limiting examples of cross-linkers include trimethylolpropane trimethacrylate (TMPTMA), divinylbenzene, di-epoxies, tri-epoxies, tetra-epoxies, di-vinyl ethers, tri-vinyl ethers, tetra-vinyl ethers, and combinations thereof.

Thermoplastic or thermosetting polymers can be used, as can crosslinked elastomers. In general, the polymers can be porous and/or amorphous. A variety of elastomeric polymeric materials is contemplated, including polymers of the general classes of silicone polymers and epoxy polymers. Polymers having low glass transition temperatures such as, for example, below 25° C. or more preferably below −50° C., can be used. Diglycidyl ethers of bisphenol A can be used, in addition to compounds based on aromatic amine, triazine, and cycloaliphatic backbones. Another example includes novolac polymers. Other contemplated elastomeric polymers include methylchlorosilanes, ethylchlorosilanes, phenylchlorosilanes, and polydimethylsiloxane (PDMS). Other materials include polyethylene, polystyrene, polybutadiene, polyurethane, polyisoprene, polyacrylic rubber, fluorosilicone rubber, and fluoroelastomers.

Further examples of suitable polymers that may be used to form a tip can be found in U.S. Pat. No. 5,776,748; U.S. Pat. No. 6,596,346; and U.S. Pat. No. 6,500,549, each of which is hereby incorporated by reference in its entirety. Other suitable polymers include those disclosed by He et al., Langmuir 2003, 19, 6982-6986; Donzel et al., Adv. Mater. 2001, 13, 1164-1167; and Martin et al., Langmuir, 1998, 14-15, 3791-3795. Hydrophobic polymers such as polydimethylsiloxane can be modified either chemically or physically by, for example, exposure to a solution of a strong oxidizer or to an oxygen plasma.

The polymer of the tip array has a suitable compression modulus and surface hardness to prevent collapse of the polymer during inking and printing, but too high a modulus and too great a surface hardness can lead to a brittle material that cannot adapt and conform to a substrate surface during printing. As disclosed in Schmid, et al., Macromolecules, 33:3042 (2000), vinyl and hydrosilane prepolymers can be tailored to provide polymers of different modulus and surface hardness. Thus, in some cases, the polymer is a mixture of vinyl and hydrosilane prepolymers, wherein the weight ratio of vinyl prepolymer to hydrosilane crosslinker is preferably at least about 5:1, 7:1, or 8:1 and preferably at most about 20:1, 15:1, or 12:1, for example in a range of about 5:1 to about 20:1, or about 7:1 to about 15:1, or about 8:1 to about 12:1.

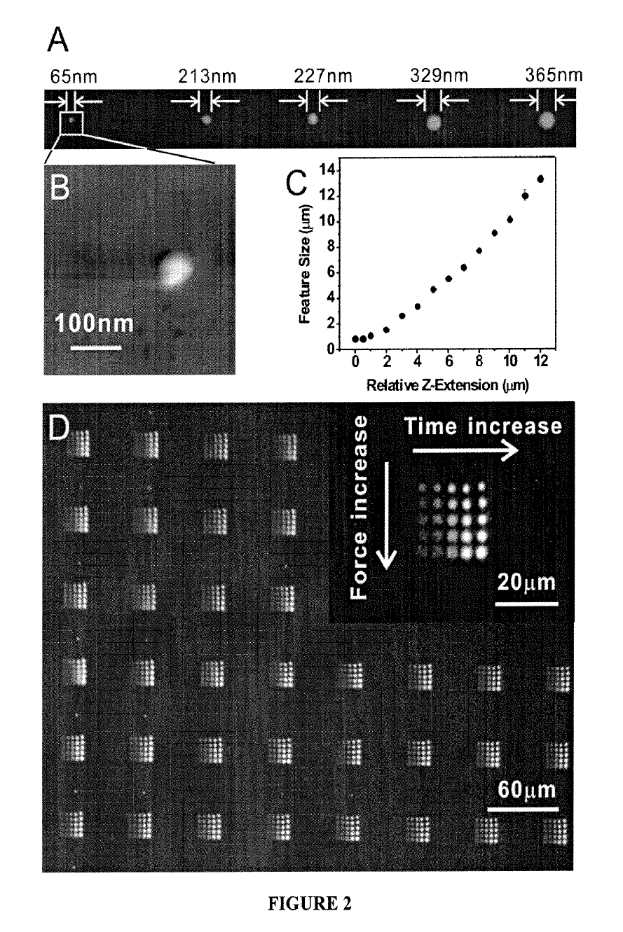

The polymers of the tip array preferably will have a surface hardness in a range of about 0.2% to about 3.5% of glass, as measured by resistance of a surface to penetration by a hard sphere with a diameter of 1 mm, compared to the resistance of a glass surface (as described in Schmid, et al., Macromolecules, 33:3042 (2000) at p 3044). The surface hardness can be in a range of about 0.3% to about 3.3%, about 0.4% to about 3.2%, about 0.5% to about 3.0%, or about 0.7% to about 2.7%. The polymers of the tip array can have a compression modulus of about 10 MPa to about 300 MPa. The tip array preferably comprises a compressible polymer which is Hookean under pressures of about 10 MPa to about 300 MPa. The linear relationship between pressure exerted on the tip array and the feature size allows for control of the indicia printed using the disclosed methods and tip arrays (see FIG. 2C).

The tip array can comprise a polymer that has adsorption and/or absorption properties for the ink composition, such that the tip array acts as its own ink composition reservoir. For example, PDMS is known to adsorb patterning inks, see, e.g., US Patent Publication No. 2004/228962, Zhang, et al., Nano Lett. 4, 1649 (2004), and Wang et al., Langmuir 19, 8951 (2003).

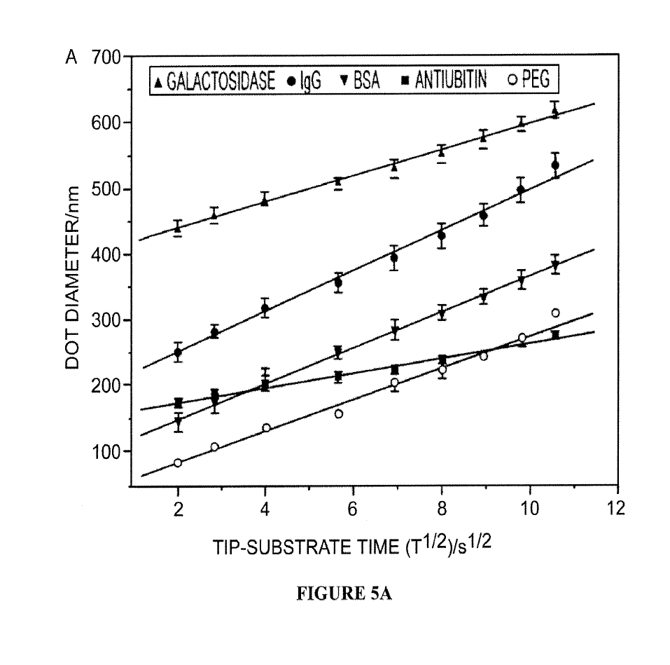

The tip array can comprise a plurality of tips fixed to a common substrate and formed from a suitable polymer, such as one disclosed herein. The tips can be arranged randomly or in a regular periodic pattern (e.g., in columns and rows, in a circular pattern, or the like). The tips can all have the same shape or be constructed to have different shapes. The common substrate can comprise an elastomeric layer, which can comprise the same polymer that forms the tips of the tip array, or can comprise an elastomeric polymer that is different from that of the tip array. The elastomeric layer of the common substrate can have a thickness of about 50 μm to about 100 μm. The combination of tip array and common substrate can be affixed or adhered to a rigid support (e.g., glass, such as a glass slide). In various cases, the common substrate, the tip array, and/or the rigid support, if present, is translucent or transparent. In a specific case, each is translucent or transparent. The thickness of combination of the tip array and common substrate, can be less than about 200 μm, preferably less than about 150 μm, or more preferably about 100 μm. An example of an arrangement of tips fixed to an elastomeric layer common substrate is shown in FIG. 4.

### Inkwells

Inkwells are used to ink the tip arrays in the disclosed methods. These inkwell arrays can have a corresponding number, shape, and placement of wells for each tip of the tip array. In some embodiments, the inkwell arrays are repurposed from the molds used to prepare the tip arrays. In such embodiments, then, the dimensions and inter-well spacings of the wells of the inkwell are substantially or completely aligned with the tips of the tip array. Such substantial or complete alignment can allow for strict control of the inking of the tips with the selected inks, with little or no cross talk and/or cross contamination of one ink to another ink or to an incorrect set of tips, in a single inking step.

Standard photolithography techniques can be used to etch a mold having a selected number of tips, in a selected arrangement. The tip array can be formed by casting a polymer on the mold. After formation of the tip array from the mold, the mold can then be used as an inkwell array for the tip array. The wells of the inkwell array can be selectively filled with various inks, such that some tips of the tip array are inked with one ink while other tips are inked with a different ink. The wells can be filled by any means available, including, but not limited, using an inkjet printer. In some cases, the inkjet printer is an electrohydrodynamic inkjet printer. See also, e.g., U.S. Pat. Nos. 7,326,439; 7,168,791; 6,997,539; 7,273,270; and 7,434,912, US Patent Publication No. 2009/0133169.

In various embodiments, the inkwell array surface (e.g., the surface which will contact the ink) is treated with a fluorinated substance. Fluorination of the inkwell surface can decrease cross contamination of the inks in the different wells, by rendering the surface hydrophobic. The hydrophobic surface will reduce the size of the inked area and reduce lateral ink diffusion on the surface. In some cases, the inkwell surface is treated with a fluorosilane, such as 1H,1H,2H,2H-perfluorodecultrichlorosilane. Other contemplated fluorinated compounds include fluoropolymers, and silanes having at least one fluorine group (e.g., chlorosilanes, methylsilanes, methoxysilances, and ethoxysilanes with at least 1 F substituent, and preferably at least 2, at least 3, at least 4, or at least 5 F substituents). Examples include bis(trifluoropropyl)tetramethyldisiloxane and (heptadecafluoro-1,1,2,2-tetrahydrodecyl)triethoxysilane.

FIG. 1C shows a polymer pen array which has a complimentary geometry to the inkwell array that was aligned and inked. Inks are selectivity addressed on the top part of the pyramidal pens. Importantly, the precise control provided by the z-piezo prevents contact between the backing layer of the polymer pen array and the banks of the inkwell array between wells. Thus, cross-contamination of inks (from physical contact or capillary forces) between neighboring pens during the inking process is prevented even if the banks of the inkwell array have excess ink. One can readily use this polymer pen array to make multiplexed protein arrays in a “direct write” fashion. As a proof-of-concept, each pen in an array was used to make a 5×5 protein dot array with 4 μm spacing between dots (FIG. 1D). Again, no crosstalk was found because of the one-step, top-down writing attribute of PPL.

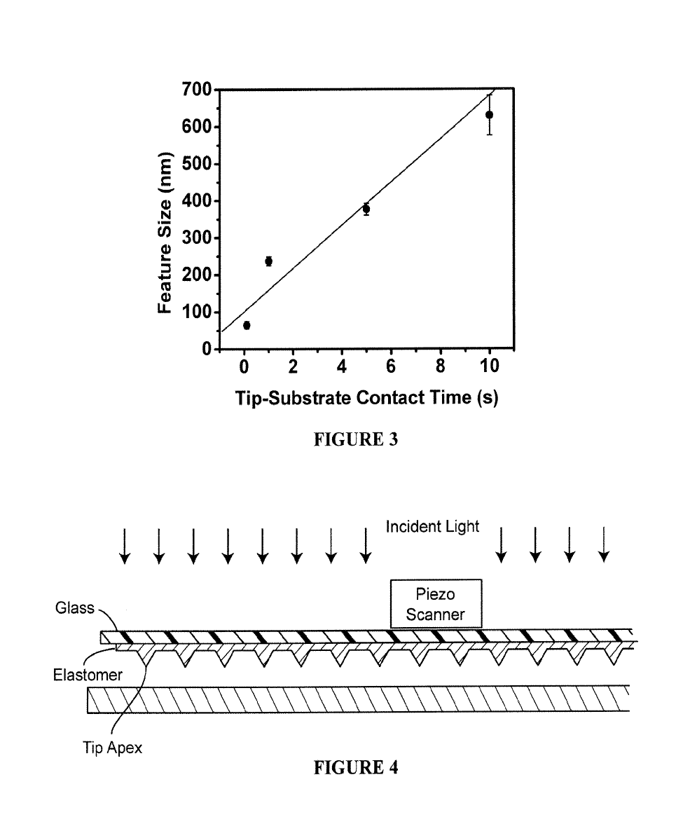

One can control the feature size from sub-100 nm to many microns by varying both the tip-substrate contact time and contact force. When the tip made initial contact with the substrate, 65 nm features were made at 0.01 s contact time (FIGS. 2A and B). The feature size increases as a function of tip-substrate contact time (FIG. 3). A unique additional capability of PPL is feature size control enabled by varying tip-substrate contact force. FIG. 2C shows the feature size of patterned proteins as a function of z-piezo extension with fixed tip-substrate contact time (10 s). At the first 500 nm extension (relative to initial contact), the size of protein features is 857±40 nm. Further extending the z-piezo results in a quasi-linear increase in feature size. For example, 13.32±0.32 μm dots were generated with 12 μm z-piezo extension in the current pen array configuration. Compared to other lithographic methods, such attributes uniquely allow one to make (sub)micron sized biomolecule (e.g, protein) arrays for optical screening purposes over large areas in only a few seconds.

Importantly, the biomolecule structures patterned by PPL maintain their biological activity. As a proof-of-concept experiment, 5×5 PSA arrays were patterned by PPL onto a Codelink slide with increasing tip-substrate contact times and contact forces. This protein chip was labeled with its corresponding antibody by immersion in a PBS (pH=7.4) solution containing 100 nM Alex Fluor 488 conjugated anti-PSA for 1 hr, followed by rinsing, drying and imaging with fluorescent microscopy. As shown in FIG. 2D, anti-PSA bound selectively onto the PSA regions with undetectable background, showing that PSA maintained its bioactivity through the polymer pen lithography process, at a minimum to the extent necessary for anti-PSA binding. The feature size increased from 1.1 μm to 3.2 with increasing contact force. Interestingly, the fluorescent intensity increased with increasing tip-substrate contact time, most likely because of lower PSA densities delivered at shorter contact times.

### Ink Compositions

Ink compositions suitable for use in the disclosed methods include both homogeneous and heterogeneous compositions, the latter referring to a composition having more than one component, and in some embodiments include at least one biomolecule. The ink composition is coated on the tip array. The term “coating,” as used herein, refers both to coating of the tip array as well adsorption and absorption by the tip array of the ink composition. Upon coating of the tip array with the ink composition, the ink composition can be patterned on a substrate surface using the tip array.

Ink compositions can be liquids, solids, semi-solids, and the like. Ink compositions suitable for use include, but are not limited to, molecular solutions, polymer solutions, pastes, gels, creams, glues, resins, epoxies, adhesives, metal films, particulates, solders, etchants, and combinations thereof.

Ink compositions can include materials such as, but not limited to, monolayer-forming species, thin film-forming species, oils, colloids, metals, metal complexes, metal oxides, ceramics, organic species (e.g., moieties comprising a carbon-carbon bond, such as small molecules, polymers, polymer precursors, proteins, antibodies, and the like), polymers (e.g., both non-biological polymers and biological polymers such as single and double stranded DNA, RNA, and the like), polymer precursors, dendrimers, nanoparticles, and combinations thereof. In some embodiments, one or more components of an ink composition includes a functional group suitable for associating with a substrate, for example, by forming a chemical bond, by an ionic interaction, by a Van der Waals interaction, by an electrostatic interaction, by magnetism, by adhesion, and combinations thereof.

In some embodiments, the ink composition can be formulated to control its viscosity. Parameters that can control ink viscosity include, but are not limited to, solvent composition, solvent concentration, thickener composition, thickener concentration, particle size of a component, the molecular weight of a polymeric component, the degree of cross-linking of a polymeric component, the free volume (i.e., porosity) of a component, the hydrodynamic radius of a component, the swellability of a component, ionic interactions between ink components (e.g., solvent-thickener interactions), and combinations thereof.

In some embodiments, the ink composition comprises an additive, such as a solvent, a thickening agent, an ionic species (e.g., a cation, an anion, a zwitterion, etc.) the selection and concentration of which can be selected to adjust one or more of the viscosity, the dielectric constant, the conductivity, the tonicity, the density, and the like, of the ink composition.

In some embodiments, the ink composition can be formulated to control its diffusion or deposition rate. In embodiments where two or more inks are deposited onto a substrate surface in a parallel manner, the diffusion or deposition rate can assist in controlling the standardization of the amount of material deposited at each location on the substrate. For example, adjusting the amount of an additive in the ink composition for a biomolecule to adjust the diffusion or deposition rate. In some cases, the amount of additive to biomolecule is in the range of about 1:1 to about 50:1, about 1:1 to about 40:1, about 1:1 to about 30:1, about 1:1 to about 250:1, about 1:1 to about 20:1, about 1:1 to about 15:1, about 1:1 to about 10:1, or about 1:1 to about 5:1, depending upon the biomolecule being patterned and the other biomolecules being patterned in parallel, such that the diffusion or deposition rates of the patterned biomolecules is standardized. See, e.g., WO 08/157,550.

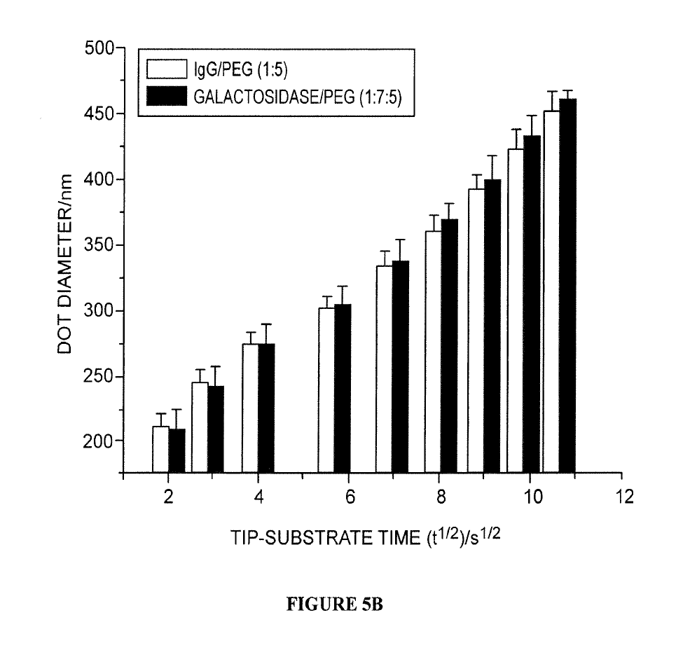

Each ink composition has its own diffusion rate, which can make it challenging for simultaneous patterning of multiple inks, and further for feature size control via the tip-substrate contact time and/or contact pressure. The ink diffusion rate varies according to different ink materials selected. For example, FIG. 5A shows plots of the relationship of dot sizes with tip-substrate contact time of selected ink materials, patterned using DPN lithography techniques, where the slopes of each plot reflects the corresponding ink's diffusion constant. Pure IgG can have a diffusion rate as high as 30.81, while that highest diffusion rate measured for anti-ubiquitin is only 11.30 (see FIG. 5A). Thus, due to diffusion rate differences, at the same tip-substrate contact time (4 sec), the generated dot size is 439.0 nm for β-galactosidase and 144.7 nm for BSA. By simple trial-and-error investigation of the diffusion rates of ink compositions of biomolecules at various concentrations of additives, one can arrive at a first ink composition with an appropriate ratio of additive to biomolecule that has a similar diffusion or deposition rate as that of a second ink composition having a particular ratio of additive to biomolecule. For example, charts showing that the ink diffusion rate of IgG and β-galactosidase can be tuned to be very close at a biomolecule/PEG ratio of 1:5 and 1:7.5, respectively, are shown in FIG. 5B.

In some specific embodiments, the ink composition can comprise glycerol as an additive. The presence of glycerol in the ink composition can assist in increasing the mobility of the ink on the tips of the polymer pen array and/or to normalize the diffusion or deposition rates of the ink compositions. The glycerol can be present in the ink in any suitable concentration, for example a concentration of at least about 0.1%, or 0.5% or 1% or 2% by weight of an ink composition and/or at most about 50%, or 25%, or 15%, or 10% by weight of an ink composition, e.g. in a range of about 0.1% to about 50% by weight, about 0.5% to about 25% by weight, about 1% to about 15% by weight, or about 2% to about 10% by weight of an ink composition.

Suitable thickening agents include, but are not limited to, metal salts of carboxyalkylcellulose derivatives (e.g., sodium carboxymethylcellulose), alkylcellulose derivatives (e.g., methylcellulose and ethylcellulose), partially oxidized alkylcellulose derivatives (e.g., hydroxyethylcellulose, hydroxypropylcellulose and hydroxypropylmethylcellulose), starches, polyacrylamide gels, homopolymers of poly-N-vinylpyrrolidone, poly(alkyl ethers) (e.g., polyethylene oxide, polyethylene glycol, and polypropylene oxide), agar, agarose, xanthan gums, gelatin, dendrimers, colloidal silicon dioxide, lipids (e.g., fats, oils, steroids, waxes, glycerides of fatty acids, such as oleic, linoleic, linolenic, and arachidonic acid, and lipid bilayers such as from phosphocholine) and combinations thereof. In some embodiments, a thickener is present in a concentration of at least about 0.5%, or 1% or 5% by weight of an ink composition, and/or at most about 25%, 20% or 15% by weight of an ink composition, e.g. in a range of about 0.5% to about 25%, about 1% to about 20%, or about 5% to about 15% by weight of an ink composition.

Suitable solvents for a ink composition include, but are not limited to, water, C1-C8 alcohols (e.g., methanol, ethanol, propanol and butanol), C6-C12 straight chain, branched and cyclic hydrocarbons (e.g., hexane and cyclohexane), C6-C14 aryl and aralkyl hydrocarbons (e.g., benzene, xylenes, and toluene), C3-C10 alkyl ketones (e.g., acetone, methyl ethyl ketone), C3-C10 esters (e.g., ethyl acetate), C4-C10 alkyl ethers (e.g., diethyl ether), and combinations thereof. In some embodiments, a solvent is present in a concentration of at least about 1%, or 5%, or 10%, or 15%, or 25%, or 50%, or 75% by weight of an ink composition, and/or at most about 99%, or 95%, or 90%, or 75%, or 50%, or 25% by weight of an ink composition, e.g. in a range of about 1% to about 99%, about 5% to about 95%, about 10% to about 90%, about 15% to about 95%, about 25% to about 95%, about 50% to about 95%, or about 75% to about 95% by weight of an ink composition.

Ink compositions can comprise an etchant. As used herein, an “etchant” refers to a component that can react with a surface to remove a portion of the surface. Thus, an etchant is used to form a subtractive feature by reacting with a surface and forming at least one of a volatile and/or soluble material that can be removed from the substrate, or a residue, particulate, or fragment that can be removed from the substrate by, for example, a rinsing or cleaning method. In some embodiments, an etchant is present in a concentration of at least about 0.5%, or 1%, or 2% by weight of an ink composition and/or at most about 95%, or 90%, or 85%, or 10% by weight of an ink composition, e.g., in a range of about 0.5% to about 95%, about 1% to about 90%, about 2% to about 85%, about 0.5% to about 10%, or about 1% to about 10% by weight of the ink composition.

Etchants suitable for use in the methods disclosed herein include, but are not limited to, an acidic etchant, a basic etchant, a fluoride-based etchant, and combinations thereof. Acidic etchants suitable for use with the present invention include, but are not limited to, sulfuric acid, trifluoromethanesulfonic acid, fluorosulfonic acid, trifluoroacetic acid, hydrofluoric acid, hydrochloric acid, carborane acid, and combinations thereof. Basic etchants suitable for use with the present invention include, but are not limited to, sodium hydroxide, potassium hydroxide, ammonium hydroxide, tetraalkylammonium hydroxide ammonia, ethanolamine, ethylenediamine, and combinations thereof. Fluoride-based etchants suitable for use with the present invention include, but are not limited to, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, and combinations thereof.

In some embodiments, the ink composition includes a reactive component. As used herein, a “reactive component” refers to a compound or species that has a chemical interaction with a substrate. In some embodiments, a reactive component in the ink penetrates or diffuses into the substrate. In some embodiments, a reactive component transforms, binds, or promotes binding to exposed functional groups on the surface of the substrate. Reactive components can include, but are not limited to, ions, free radicals, metals, acids, bases, metal salts, organic reagents, and combinations thereof. Reactive components further include, without limitation, monolayer-forming species such as thiols, hydroxides, amines, silanols, siloxanes, and the like, and other monolayer-forming species known to a person or ordinary skill in the art. The reactive component can be present in a concentration of at least about 0.001%, or 0.01%, or 0.1% by weight of an ink composition and/or at most about 95%, or 50%, or 25%, or 5% by weight of an ink composition, e.g., about 0.001% to about 95%, about 0.001% to about 50%, about 0.001% to about 25%, about 0.001% to about 10%, about 0.001% to about 5%, about 0.001% to about 2%, about 0.001% to about 1%, about 0.001% to about 0.5%, about 0.001% to about 0.05%, about 0.01% to about 10%, about 0.01% to about 5%, about 0.01% to about 2%, about 0.01% to about 1%, about 10% to about 100%, about 50% to about 99%, about 70% to about 95%, about 80% to about 99%, about 0.001%, about 0.005%, about 0.01%, about 0.1%, about 0.5%, about 1%, about 2%, or about 5% weight of the ink composition.

The ink composition can further comprise a conductive and/or semi-conductive component. As used herein, a “conductive component” refers to a compound or species that can transfer or move electrical charge. Conductive and semi-conductive components include, but are not limited to, a metal, a nanoparticle, a polymer, a cream solder, a resin, and combinations thereof. In some embodiments, a conductive component is present in a concentration of at least about 1%, or 5%, or 50% by weight of an ink composition and/or at most about 99%, or 95%, or 90%, or 50%, or 5% by weight of an ink composition, e.g., about 1% to about 99%, about 1% to about 10%, about 5% to about 99%, about 25% to about 99%, about 50% to about 99%, about 75% to about 99%, about 2%, about 5%, about 90%, or about 95% by weight of the ink composition.

Metals suitable for use in an ink composition include, but are not limited to, a transition metal, aluminum, silicon, phosphorous, gallium, germanium, indium, tin, antimony, lead, bismuth, alloys thereof, and combinations thereof.

In some embodiments, the ink composition comprises a semi-conductive polymer. Semi-conductive polymers suitable for use with the disclosed methods include, but are not limited to, a polyaniline, a poly(3,4-ethylenedioxythiophene)-poly(styrenesulfonate), a polypyrrole, an arylene vinylene polymer, a polyphenylenevinylene, a polyacetylene, a polythiophene, a polyimidazole, and combinations thereof.

The ink composition can include an insulating component. As used herein, an “insulating component” refers to a compound or species that is resistant to the movement or transfer of electrical charge. In some embodiments, an insulating component has a dielectric constant of about 1.5 to about 8 about 1.7 to about 5, about 1.8 to about 4, about 1.9 to about 3, about 2 to about 2.7, about 2.1 to about 2.5, about 8 to about 90, about 15 to about 85, about 20 to about 80, about 25 to about 75, or about 30 to about 70. Insulating components suitable for use in the methods disclosed herein include, but are not limited to, a polymer, a metal oxide, a metal carbide, a metal nitride, monomeric precursors thereof, particles thereof, and combinations thereof. Suitable polymers include, but are not limited to, a polydimethylsiloxane, a silsesquioxane, a polyethylene, a polypropylene, a polyimide, and combinations thereof. In some embodiments, for example, an insulating component is present in a concentration of at least about 1%, or 5%, or 50% by weight of an ink composition and/or at most about 99%, or 95%, or 90%, or 50%, or 5% by weight of an ink composition, e.g., about 1% to about 95%, about 1% to about 80%, about 1% to about 50%, about 1% to about 20%, about 1% to about 10%, about 20% to about 95%, about 20% to about 90%, about 40% to about 80%, about 1%, about 5%, about 10%, about 90%, or about 95% by weight of the ink composition.

The ink composition can include a masking component. As used herein, a “masking component” refers to a compound or species that upon reacting forms a surface feature resistant to a species capable of reacting with the surrounding surface. Masking components suitable for use with the present invention include materials commonly employed in traditional photolithography methods as “resists” (e.g., photoresists, chemical resists, self-assembled monolayers, etc.). Masking components suitable for use in the disclosed methods include, but are not limited to, a polymer such as a polyvinylpyrollidone, poly(epichlorohydrin-co-ethyleneoxide), a polystyrene, a poly(styrene-co-butadiene), a poly(4-vinylpyridine-co-styrene), an amine terminated poly(styrene-co-butadiene), a poly(acrylonitrile-co-butadiene), a styrene-butadiene-styrene block copolymer, a styrene-ethylene-butylene block linear copolymer, a polystyrene-block-poly(ethylene-ran-butylene)-block-polystyrene, a poly(styrene-co-maleic anhydride), a polystyrene-block-poly(ethylene-ran-butylene)-block-polystyrene-graft-maleic anhydride, a polystyrene-block-polyisoprene-block-polystyrene, a polystyrene-block-poly(ethylene-ran-butylene)-block-polystyrene, a polynorbornene, a dicarboxy terminated poly(acrylonitrile-co-butadiene-co-acrylic acid), a dicarboxy terminated poly(acrylonitrile-co-butadiene), a polyethyleneimine, a poly(carbonate urethane), a poly(acrylonitrile-co-butadiene-co-styrene), a poly(vinylchloride), a poly(acrylic acid), a poly(methylmethacrylate), a poly(methyl methacrylate-co-methacrylic acid), a polyisoprene, a poly(1,4-butylene terephthalate), a polypropylene, a poly(vinyl alcohol), a poly(1,4-phenylene sulfide), a polylimonene, a poly(vinylalcohol-co-ethylene), a poly[N,N′-(1,3-phenylene)isophthalamide], a poly(1,4-phenylene ether-ether-sulfone), a poly(ethyleneoxide), a poly[butylene terephthalate-co-poly(alkylene glycol) terephthalate], a poly(ethylene glycol) diacrylate, a poly(4-vinylpyridine), a poly(DL-lactide), a poly(3,3′,4,4′-benzophenonetetracarboxylic dianhydride-co-4,4′-oxydianiline/1,3-phenylenediamine), an agarose, a polyvinylidene fluoride homopolymer, a styrene butadiene copolymer, a phenolic resin, a ketone resin, a 4,5-difluoro-2,2-bis(trifluoromethyl)-1,3-dioxane, a salt of any of the foregoing, and combinations of any of the foregoing. In some embodiments, a masking component is present in a concentration of at least about 1%, or 2% by weight of the ink composition, and/or at most about 10%, or 5% or 2% by weight of the ink composition, for example in a range of about 1% to about 10%, about 1% to about 5%, or about 2% by weight of the ink composition.

The ink composition can include a conductive component and a reactive component. For example, a reactive component can promote at least one of: penetration of a conductive component into a surface, reaction between the conductive component and a surface, adhesion between a conductive feature and a surface, promoting electrical contact between a conductive feature and a surface, and combinations thereof. Surface features formed by reacting this ink composition include conductive features selected from the group consisting of: additive non-penetrating, additive penetrating, subtractive penetrating, and conformal penetrating surface features.

The ink composition can comprise an etchant and a conductive component, for example, suitable for producing a subtractive surface feature having a conductive feature inset therein.

The ink composition can comprise an insulating component and a reactive component. For example, a reactive component can promote at least one of: penetration of an insulating component into a surface, reaction between the insulating component and a surface, adhesion between an insulating feature and a surface, promoting electrical contact between an insulating feature and a surface, and combinations thereof. Surface features formed by reacting this ink composition include insulating features selected from the group consisting of: additive non-penetrating, additive penetrating, subtractive penetrating, and conformal penetrating surface features.

The ink composition can comprise an etchant and an insulating component, for example, suitable for producing a subtractive surface feature having an insulating feature inset therein.

The ink composition can comprise a conductive component and a masking component, for example, suitable for producing electrically conductive masking features on a surface.

Other contemplated components of an ink composition suitable for use with the disclosed methods include thiols, 1,9-nonanedithiol solution, silane, silazanes, alkynes cystamine, N-Fmoc protected amino thiols, biomolecules, DNA, proteins, antibodies, collagen, peptides, biotin, and carbon nanotubes.

For a description of ink compounds and ink compositions, and their preparation and use, see Xia and Whitesides, Angew. Chem. Int. Ed., 37, 550-575 (1998) and references cited therein; Bishop et al., Curr. Opinion Colloid & Interface Sci., 1, 127-136 (1996); Calvert, J. Vac. Sci. Technol. B, 11, 2155-2163 (1993); Ulman, Chem. Rev., 96:1533 (1996) (alkanethiols on gold); Dubois et al., Annu. Rev. Phys. Chem., 43:437 (1992) (alkanethiols on gold); Ulman, An Introduction to Ultrathin Organic Films: From Langmuir-Blodgett to Self-Assembly (Academic, Boston, 1991) (alkanethiols on gold); Whitesides, Proceedings of the Robert A. Welch Foundation 39th Conference On Chemical Research Nanophase Chemistry, Houston, Tex., pages 109-121 (1995) (alkanethiols attached to gold); Mucic et al. Chem. Commun. 555-557 (1996) (describes a method of attaching 3′ thiol DNA to gold surfaces); U.S. Pat. No. 5,472,881 (binding of oligonucleotide-phosphorothiolates to gold surfaces); Burwell, Chemical Technology, 4, 370-377 (1974) and Matteucci and Caruthers, J. Am. Chem. Soc., 103, 3185-3191 (1981) (binding of oligonucleotides-alkylsiloxanes to silica and glass surfaces); Grabar et al., Anal. Chem., 67, 735-743 (binding of aminoalkylsiloxanes and for similar binding of mercaptoalkylsiloxanes); Nuzzo et al., J. Am. Chem. Soc., 109, 2358 (1987) (disulfides on gold); Allara and Nuzzo, Langmuir, 1, 45 (1985) (carboxylic acids on aluminum); Allara and Tompkins, J. Colloid Interfate Sci., 49, 410-421 (1974) (carboxylic acids on copper); Iler, The Chemistry Of Silica, Chapter 6, (Wiley 1979) (carboxylic acids on silica); Timmons and Zisman, J. Phys. Chem., 69, 984-990 (1965) (carboxylic acids on platinum); Soriaga and Hubbard, J. Am. Chem. Soc., 104, 3937 (1982) (aromatic ring compounds on platinum); Hubbard, Acc. Chem. Res., 13, 177 (1980) (sulfolanes, sulfoxides and other functionalized solvents on platinum); Hickman et al., J. Am. Chem. Soc., 111, 7271 (1989) (isonitriles on platinum); Maoz and Sagiv, Langmuir, 3, 1045 (1987) (silanes on silica); Maoz and Sagiv, Langmuir, 3, 1034 (1987) (silanes on silica); Wasserman et al., Langmuir, 5, 1074 (1989) (silanes on silica); Eltekova and Eltekov, Langmuir, 3,951 (1987) (aromatic carboxylic acids, aldehydes, alcohols and methoxy groups on titanium dioxide and silica); Lee et al., J. Phys. Chem., 92, 2597 (1988) (rigid phosphates on metals); Lo et al., J. Am. Chem. Soc., 118, 11295-11296 (1996) (attachment of pyrroles to superconductors); Chen et al., J. Am. Chem. Soc., 117, 6374-5 (1995) (attachment of amines and thiols to superconductors); Chen et al., Langmuir, 12, 2622-2624 (1996) (attachment of thiols to superconductors); McDevitt et al., U.S. Pat. No. 5,846,909 (attachment of amines and thiols to superconductors); Xu et al., Langmuir, 14, 6505-6511 (1998) (attachment of amines to superconductors); Mirkin et al., Adv. Mater. (Weinheim, Ger.), 9, 167-173 (1997) (attachment of amines to superconductors); Hovis et al., J. Phys. Chem. B, 102, 6873-6879 (1998) (attachment of olefins and dienes to silicon); Hovis et al., Surf Sci., 402-404, 1-7 (1998) (attachment of olefins and dienes to silicon); Hovis et al., J. Phys. Chem. B, 101, 9581-9585 (1997) (attachment of olefins and dienes to silicon); Hamers et al., J. Phys. Chem. B, 101, 1489-1492 (1997) (attachment of olefins and dienes to silicon); Hamers et al., U.S. Pat. No. 5,908,692 (attachment of olefins and dienes to silicon); Ellison et al., J. Phys. Chem. B, 103, 6243-6251 (1999) (attachment of isothiocyanates to silicon); Ellison et al., J. Phys. Chem. B, 102, 8510-8518 (1998) (attachment of azoalkanes to silicon); Ohno et al., Mol. Cryst. Liq. Cryst. Sci. Technol., Sect. A, 295, 487-490 (1997) (attachment of thiols to GaAs); Reuter et al., Mater. Res. Soc. Symp. Proc., 380, 119-24 (1995) (attachment of thiols to GaAs); Bain, Adv. Mater. (Weinheim, Fed. Repub. Ger.), 4, 591-4 (1992) (attachment of thiols to GaAs); Sheen et al., J. Am. Chem. Soc., 114, 1514-15 (1992) (attachment of thiols to GaAs); Nakagawa et al., Jpn. J. Appl. Phys., Part 1, 30, 3759-62 (1991) (attachment of thiols to GaAs); Lunt et al., J. Appl. Phys., 70, 7449-67 (1991) (attachment of thiols to GaAs); Lunt et al., J. Vac. Sci. Technol., B, 9, 2333-6 (1991) (attachment of thiols to GaAs); Yamamoto et al., Langmuir ACS ASAP, web release number Ia990467r (attachment of thiols to InP); Gu et al., J. Phys. Chem. B, 102, 9015-9028 (1998) (attachment of thiols to InP); Menzel et al., Adv. Mater. (Weinheim, Ger.), 11, 131-134 (1999) (attachment of disulfides to gold); Yonezawa et al., Chem. Mater., 11, 33-35 (1999) (attachment of disulfides to gold); Porter et al., Langmuir, 14, 7378-7386 (1998) (attachment of disulfides to gold); Son et al., J. Phys. Chem., 98, 8488-93 (1994) (attachment of nitriles to gold and silver); Steiner et al., Langmuir, 8, 2771-7 (1992) (attachment of nitriles to gold and copper); Solomun et al., J. Phys. Chem., 95, 10041-9 (1991) (attachment of nitriles to gold); Solomun et al., Ber. Bunsen-Ges. Phys. Chem., 95, 95-8 (1991) (attachment of nitriles to gold); Henderson et al., Inorg. Chim. Acta, 242, 115-24 (1996) (attachment of isonitriles to gold); Huc et al., J. Phys. Chem. B, 103, 10489-10495 (1999) (attachment of isonitriles to gold); Hickman et al., Langmuir, 8, 357-9 (1992) (attachment of isonitriles to platinum); Steiner et al., Langmuir, 8, 90-4 (1992) (attachment of amines and phosphines to gold and attachment of amines to copper); Mayya et al., J. Phys. Chem. B, 101, 9790-9793 (1997) (attachment of amines to gold and silver); Chen et al., Langmuir, 15, 1075-1082 (1999) (attachment of carboxylates to gold); Tao, J. Am. Chem. Soc., 115, 4350-4358 (1993) (attachment of carboxylates to copper and silver); Laibinis et al., J. Am. Chem. Soc., 114, 1990-5 (1992) (attachment of thiols to silver and copper); Laibinis et al., Langmuir, 7, 3167-73 (1991) (attachment of thiols to silver); Fenter et al., Langmuir, 7, 2013-16 (1991) (attachment of thiols to silver); Chang et al., J. Am. Chem. Soc., 116, 6792-805 (1994) (attachment of thiols to silver); Li et al., J. Phys. Chem., 98, 11751-5 (1994) (attachment of thiols to silver); Tarlov et al., U.S. Pat. No. 5,942,397 (attachment of thiols to silver and copper); Waldeck, et al., WIPO PCT publication WO/99/48682 (attachment of thiols to silver and copper); Gui et al., Langmuir, 7, 955-63 (1991) (attachment of thiols to silver); Walczak et al., J. Am. Chem. Soc., 113, 2370-8 (1991) (attachment of thiols to silver); Sangiorgi et al., Gazz. Chim. Ital., 111, 99-102 (1981) (attachment of amines to copper); Magallon et al., Book of Abstracts, 215th ACS National Meeting, Dallas, Mar. 29-Apr. 2, 1998, COLL-048 (attachment of amines to copper); Patil et al., Langmuir, 14, 2707-2711 (1998) (attachment of amines to silver); Sastry et al., J. Phys. Chem. B, 101, 4954-4958 (1997) (attachment of amines to silver); Bansal et al., J. Phys. Chem. B. 102, 4058-4060 (1998) (attachment of alkyl lithium to silicon); Bansal et al., J. Phys. Chem. B, 102, 1067-1070 (1998) (attachment of alkyl lithium to silicon); Chidsey, Book of Abstracts, 214th ACS National Meeting, Las Vegas, Nev., Sep. 7-11, 1997, I&EC-027 (attachment of alkyl lithium to silicon); Song, J. H., Thesis, University of California at San Diego (1998) (attachment of alkyl lithium to silicon dioxide); Meyer et al., J. Am. Chem. Soc., 110, 4914-18 (1988) (attachment of amines to semiconductors); Brazdil et al. J. Phys. Chem., 85, 1005-14 (1981) (attachment of amines to semiconductors); James et al., Langmuir, 14, 741-744 (1998) (attachment of proteins and peptides to glass); Bernard et al., Langmuir, 14, 2225-2229 (1998) (attachment of proteins to glass, polystyrene, gold, silver and silicon wafers); Pereira et al., J. Mater. Chem., 10, 259 (2000) (attachment of silazanes to SiO₂); Pereira et al., J. Mater. Chem., 10, 259 (2000) (attachment of silazanes to SiO₂); Dammel, Diazonaphthoquinone Based Resists (1st ed., SPIE Optical Engineering Press, Bellingham, Wash., 1993) (attachment of silazanes to SiO₂); Anwander et al., J. Phys. Chem. B, 104, 3532 (2000) (attachment of silazanes to SiO₂); Slavov et al., J. Phys. Chem., 104, 983 (2000) (attachment of silazanes to SiO₂).

### Substrates to be Patterned

Substrates suitable for use in methods disclosed herein include, but are not limited to, metals, alloys, composites, crystalline materials, amorphous materials, conductors, semiconductors, optics, fibers, inorganic materials, glasses, ceramics (e.g., metal oxides, metal nitrides, metal silicides, and combinations thereof), zeolites, polymers, plastics, organic materials, minerals, biomaterials, living tissue, bone, films thereof, thin films thereof, laminates thereof, foils thereof, composites thereof, and combinations thereof. A substrate can comprise a semiconductor such as, but not limited to: crystalline silicon, polycrystalline silicon, amorphous silicon, p-doped silicon, n-doped silicon, silicon oxide, silicon germanium, germanium, gallium arsenide, gallium arsenide phosphide, indium tin oxide, and combinations thereof. A substrate can comprise a glass such as, but not limited to, undoped silica glass (SiO₂), fluorinated silica glass, borosilicate glass, borophosphorosilicate glass, organosilicate glass, porous organosilicate glass, and combinations thereof. The substrate can be a non-planar substrate, such as pyrolytic carbon, reinforced carbon-carbon composite, a carbon phenolic resin, and the like, and combinations thereof. A substrate can comprise a ceramic such as, but not limited to, silicon carbide, hydrogenated silicon carbide, silicon nitride, silicon carbonitride, silicon oxynitride, silicon oxycarbide, high-temperature reusable surface insulation, fibrous refractory composite insulation tiles, toughened unipiece fibrous insulation, low-temperature reusable surface insulation, advanced reusable surface insulation, and combinations thereof. A substrate can comprise a flexible material, such as, but not limited to: a plastic, a metal, a composite thereof, a laminate thereof, a thin film thereof, a foil thereof, and combinations thereof.

Leveling of Tip Arrays and Deposition of Ink Composition onto Substrate Surface

The disclosed methods provide the ability for in situ imaging capabilities, similar to scanning probe microscope-based lithography methods (e.g., dip pen lithography) as well as the ability to pattern a feature in a fast fashion, similar to micro-contact printing. The features that can be patterned range from sub-100 nm to 1 mm in size or greater, and can be controlled by altering the contacting time and/or the contacting pressure of the tip array. Similar to DPN, the amount of ink composition (as measured by feature size) deposited onto a substrate surface is proportional to the contacting time, specifically a square root correlation with contacting time. Unlike DPN, the contacting pressure of the tip array can be used to modify the amount of ink composition that can be deposited onto the substrate surface. The pressure of the contact can be controlled by the z-piezo of a piezo scanner. The more pressure (or force) exerted on the tip array, the larger the feature size. Thus, any combination of contacting time and contacting force/pressure can provide a means for the formation of a feature size from about 30 nm to about 1 mm or greater. The ability to prepare features of such a wide range of sizes and in a “direct writing” or in situ manner in milliseconds makes the disclosed lithography method adaptable to a host of lithography applications, including electronics (e.g., patterning circuits) and biotechnology (e.g., arraying targets for biological assays). The contacting pressure of the tip array can be in a range of about 10 MPa to about 300 MPa, for example.

At very low contact pressures, such as pressures of about 0.01 to about 0.1 g/cm² for the preferred materials described herein, the feature size of the resulting indicia is independent of the contacting pressure, which allows for one to level the tip array on the substrate surface without changing the feature size of the indicia. Such low pressures are achievable by 0.5 μm or less extensions of the z-piezo of a piezo scanner to which a tip array is mounted, and pressures of about 0.01 g/cm² to about 0.1 g/cm² can be applied by z-piezo extensions of less than 0.5 μm. This “buffering” pressure range allows one to manipulate the tip array, substrate, or both to make initial contact between tips and substrate surface without compressing the tips, and then using the degree of compression of tips (observed by changes in reflection of light off the inside surfaces of the tips) to achieve a uniform degree of contact between tips and substrate surface. This leveling ability is important, as non-uniform contact of the tips of the tip array can lead to non-uniform indicia. Given the large number of tips of the tip array (e.g., 11 million) and their small size, as a practical matter it may be difficult or impossible to know definitively if all of the tips are in contact with the surface. For example, a defect in a tip or the substrate surface, or an irregularity in a substrate surface, may result in a single tip not making contact while all other tips are in uniform contact. Thus, the disclosed methods provide for at least substantially all of the tips to be in contact with the substrate surface (e.g., to the extent detectable). For example, at least 90%, at least 95%, at least 96%, at least 97%, at least 98%, or at least 99% of the tips will be in contact with the substrate surface. See, e.g., WO 09/132,321.

The leveling of the tip array and substrate surface with respect to one another can be assisted by the fact that with a transparent, or at least translucent, tip array and common substrate arrangement, one can observe the change in reflection of light that is directed from the top of the tip array (i.e., behind the base of the tips and common substrate) through to the substrate surface. The intensity of light reflected from the tips of the tip array gets greater upon contact with the substrate surface (e.g., the internal surfaces of the tip array reflect light differently upon contact). By observing the change in reflection of light at each tip, one can adjust the tip array and/or the substrate surface to effect contact of substantially all or all of the tips of the tip array to the substrate surface. Thus, the tip array and common substrate preferably are translucent or transparent to allow for observing the change in light reflection of the tips upon contact with the substrate surface. Likewise, any rigid backing material to which the tip array is mounted is also preferably at least translucent or transparent.

The contacting time for the tips can be from about 0.001 s to about 60 s, depending upon the amount of ink composition desired in any specific point on a substrate surface. The contacting force can be controlled by altering the z-piezo of a piezo scanner or by other means that allow for controlled application of force across the tip array.

The substrate surface can be contacted with a tip array a plurality of times, wherein the tip array, the substrate surface or both move to allow for different portions of the substrate surface to be contacted. The time and pressure of each contacting step can be the same or different, depending upon the desired pattern. The shape of the indicia or patterns has no practical limitation, and can include dots, lines (e.g., straight or curved, formed from individual dots or continuously), a preselected pattern, or any combination thereof.

The indicia resulting from the disclosed methods have a high degree of sameness, and thus are uniform or substantially uniform in size, and preferably also in shape and/or density. Feature size can be gauged by any suitable method, for example dot diameter, line width, width of widest point, or width of narrowest point. The individual indicia feature size (e.g., a dot diameter or line width) is highly uniform, for example within a tolerance of about 5%, or about 1%, or about 0.5%. The tolerance can be about 0.9%, about 0.8%, about 0.7%, about 0.6%, about 0.4%, about 0.3%, about 0.2%, or about 0.1%. Non-uniformity of feature size and/or shape can lead to roughness of indicia that can be undesirable for sub-micron type patterning.

The feature size can be about 10 nm to about 1 mm, about 10 nm to about 500 μm, about 10 nm to about 100 μm, about 50 nm to about 100 μm, about 50 nm to about 50 μm, about 50 nm to about 10 μm, about 50 nm to about 5 μm, or about 50 nm to about 1 μm. Features sizes can be less than 1 μm, less than about 900 nm, less than about 800 nm, less than about 700 nm, less than about 600 nm, less than about 500 nm, less than about 400 nm, less than about 300 nm, less than about 200 nm, less than about 100 nm, or less than about 90 nm.

The features patterned using the methods disclosed herein can be separated on the substrate surface, dictated by the separation of the differently inked tips of the tip array and the feature size of the indicia. The features can be separated, e.g., by a distance of less than 500 μm, less than 400 μm, less than 300 μm, less than 200 μm, or less than 100 μm.

Density of the indicia refers to the amount of biomolecule present in the area of a particular indicium (e.g., concentration). The individual indicia densities can be within a tolerance of about 5%, or about 1%, or about 0.5%. The tolerance can be about 0.9%, about 0.8%, about 0.7%, about 0.6%, about 0.4%, about 0.3%, about 0.2%, or about 0.1%.

### Patterned Substrates

Also disclosed herein are substrates that have been patterned, which can be made using the disclosed techniques, such as, e.g., an article having two or more biomolecules patterned on the substrate surface. In some embodiments, the article comprises indicia comprising a first biomolecule and indicia comprising a second biomolecule. Because the disclosed methods allow for control of the placement of the indicia and allow for no or substantially no cross contamination of the multiple inks to incorrect tips, the surfaces can be patterned with indicia from different inks, such that the indicia are separated by small distances, e.g., 750 μm or less, 500 μm or less, 400 μm or less, 300 μm or less, 200 μm or less, or 100 μm or less. Such high density of indicia of different biomolecules provides an efficient assay chip which can be used in a variety of assays, e.g. to assess biological activity of molecules of interest against a host of possible targets. The present patterned substrates also allow for formation of indicia of different biomolecules that have the same or substantially the same density of the biomolecule. In some cases, the indicia have feature size of about 10 nm to about 1 mm, about 10 nm to about 500 μm, about 10 nm to about 100 μm, about 50 nm to about 100 μm, about 50 nm to about 50 μm, about 50 nm to about 10 μm, about 50 nm to about 5 μm, or about 50 nm to about 1 μm. Features sizes can be less than 1 μm, less than about 900 nm, less than about 800 nm, less than about 700 nm, less than about 600 nm, less than about 500 nm, less than about 400 nm, less than about 300 nm, less than about 200 nm, less than about 100 nm, or less than about 90 nm.

### EXAMPLES

Materials. Si wafers <100> with 500 nm thermally deposited SiO₂ were purchased from Silicon Quest International. Codelink slides were purchased from SurModics. Shipley1805 photoresist and MF319 developing solution, were purchased from MicroChem. 1H,1H,2H,2H-perfluorodecyltrichlorosilane was purchased from Gelest. TRITC conjugated anti-mouse IgG, bovine serum albumin (BSA), prostate specific antigen (PSA) proteins were purchased from Sigma-Aldrich. Anti-PSA was purchased from R and D Systems. Alexa Fluor 488 and 647 monoclonal antibody labeling kits and anti-cholera toxin beta (anti-CTβ) antibodies were purchased from Invitrogen. The antibodies were labeled with the Alexa Fluor dyes following the manufacturer's instructions. 500 mL of 150 mM PBS (pH=8.0) was made by dissolving 10.119 g Na₂HPO₄ (Sigma-Aldrich) and 0.4487 g NaH₂PO₄ (Sigma-Aldrich) into 500 mL deionized water. HF etching solution was purchased from Transene Company. Isopropanol and acetone were purchased from Fisher.

Antibody labeling. After the antigens were bound to the slides, they were rinsed with 0.15 M PBS supplemented with 0.1% Tween 20. Then, the labeled antibodies were each diluted to a final concentration of 100 nM in 0.15 M PBS with 0.025% Tween 20 and 0.1% BSA and incubated with the surface bound antigens for 1 hr. The slide was then rinsed with the 0.15 M PBS and Tween 20 solution, briefly rinsed with water, and spun dry.

Fabrication of Si inkwells and Si masters. Shipley1805 (MicroChem, Inc.) photoresist was spin-coated onto Si wafers with 500 nm thick SiO₂ top layer. Square well arrays were fabricated by photolithography using a chrome mask. The photoresist patterns were developed in an MF319 developing solution, and then exposed to O₂ plasma for 30 s (200 mTorr) to remove the residual organic layer. Subsequently, the substrates were placed in the HF etching solution for 6 min. Copious rinsing with MiliQ water was required after each etching step to clean the surface. The photoresist was then washed away with acetone to expose the SiO₂ pattern. The SiO₂ patterned substrate was placed in a KOH etching solution (30% KOH in H₂O:isopropanol (4:1 v/v)) at 75° C. for about 2.5 hr with vigorous stirring. The uncovered areas of the Si wafer were etched anisotropically, resulting in the formation of recessed pyramids. The remaining SiO₂ layer was removed by HF etching solution again. Finally, the pyramid inkwell/master was modified with 1H,1H,2H,2H-perfluorodecyltrichlorosilane by gas phase silanization.

Fabrication of polymer pen arrays. Hard PDMS (h-PDMS) was used for fabricating the polymer pen arrays. The h-PDMS was composed of 3.4 g of vinyl-compound-rich prepolymer (VDT-731, Gelest) and 1.0 g of hydrosilane-rich crosslinker (HMS-301). Preparation of polymers typically required the addition of 20 ppm w/w platinum catalyst to the vinyl fraction (platinumdivinyltetramethyldisiloxane complex in xylene, SIP 6831.1, Gelest) and 0.1% w/w modulator to the mixture (2,4,6,8-tetramethyltetravinylcyclotetrasiloxane, Fluka). The mixture was stirred, degassed, and poured on top of the polymer pen array master. A pre-cleaned glass slide was then placed on top of the elastomer array and the whole assembly was cured at 70° C. overnight. The polymer pen array was finally separated from the pyramid master and then used for polymer pen lithography experiments.

Inking of polymer pen array and patterning of substrate with inked polymer pen array. A Si inkwell array with inter-well spacings and dimensions matching those of the polymer pen array were first filled with protein inks by inkjet printing. The ink solution was composed of 0.1 mg/mL of protein molecules and 5 wt % of glycerol in phosphate buffered saline (PBS, pH=8.0). Note that the glycerol molecules serve as a carrier to increase the mobility of the ink on the polymer pens. A Piezorray (PerkinElmer, Waltham, Mass.) inkjet printer was programmed through priming, aspiration, and dispense cycles to selectively address and ink (fill) each well with protein molecules of interest without contaminating neighboring wells. Each well of the inkwell array was filled with two 320 pL droplets of the protein ink.

Subsequently, a polymer pen array was treated with oxygen plasma for 30 s to render the surface hydrophilic, which minimizes the nonspecific adhesion of protein molecules. The hydrophilic pen array was placed in a nanolithographic instrument (such as an NSCRIPTOR™ from NanoInk, Skokie, Ill. or a Park AFM platform XEP from Park Systems Co., Suwon, Korea) and dipped in the inkwell at about 90% humidity for about 10 min by bringing the tips of the pen array into contact with the wells of the inkwell array. Because the polymer pen array is transparent, one can easily level, align, and dip this 2D pen array in the inkwell array and confirm inking optically. The inked polymer pen array was then used to write directly on a Codelink™ slide which was modified with N-hydroxysuccinimide (NHS) ester-terminated functional groups on the surface. The patterned slide was incubated overnight at 4° C. to allow the amine groups on the proteins to react with the NHS esters. Finally, the slide was passivated with bovine serum albumin (BSA) for 1 hr, rinsed with PBS buffer, and dried.

Assaying using the patterned substrate. 5×5 prostate specific antigen (PSA) arrays were patterned by PPL onto a Codelink™ slide with increasing tip-substrate contact times and contact forces. This protein chip was labeled with its corresponding antibody by immersion in a PBS (pH=7.4) solution containing 100 nM Alex Fluor 488 conjugated anti-PSA for 1 hr, followed by rinsing, drying and imaging with fluorescent microscopy. As shown in FIG. 2D, anti-PSA bound selectively onto the PSA regions with undetectable background, showing that PSA maintained its bioactivity through the polymer pen lithography process. The feature size increased from 1.1 μm to 3.2 μm with increasing contact force. Interestingly, the fluorescent intensity increased with increasing tip-substrate contact time, most likely because of lower PSA densities deposited at shorter contact times.

The foregoing describes and exemplifies the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved.

All patents, publications and references cited herein are hereby fully incorporated herein by reference. In case of conflict between the present disclosure and incorporated patents, publications and references, the present disclosure should control.

### REFERENCES

(1) Mirkin, ACS Nano 2007, 1, 79-83.
(2) Balboni, et al., Annu. Rev. Immuno. 2006, 24, 391-418.
(3) Jonkheijm, et al., Angew. Chem. Int. Ed. 2008, 47, 9618-9647.
(4) Christman, et al., Soft Matter 2006, 2, 928-939.
(5) Chen, et al., Science 1997, 276, 1425-1428.
(6) Yousaf, et al., Proc. Natl. Acad. Sci. 2001, 98, 5992-5996.
(7) Lee, et al., Science 2002, 295, 1702-1705.
(8) Bernard, et al., Adv. Mater. 2000, 12, 1067-1070.
(9) Duan, et al., Langmuir 2008, 24, 3621-3627.
(10) Hoff, et al., Nano Letters 2004, 4, 853-857.
(11) Pavlovic, et al., Nano Letters 2003, 3, 779-781.
(12) Kenseth, et al., Langmuir 2001, 17, 4105-4112.
(13) Piner, et al., Science 1999, 283, 661-663.
(14) Ginger, et al., Angew. Chem. Int. Ed. 2004, 43, 30-45.
(15) Salaita, et al., Nat. Nanotech. 2007, 2, 145-155.
(16) Lee, et al., J. Am. Chem. Soc. 2003, 125, 5588-5589.
(17) Lee, et al., Adv. Mater. 2006, 18, 1133-+.
(18) Hong, et al., Science 2000, 288, 1808-1811.
(19) Lenhert, et al., Small 2007, 3, 71-75.
(20) Salaita, et al., Angew. Chem. Int. Ed. 2006, 45, 7220-7223.
(21) Zheng, et al., Angew. Chem. Int. Ed. 2008, 47, 9951-9954.
(22) Wang, et al., Small 2008, 4, 1666-1670.
(23) Huo, et al., Science 2008, 321, 1658-1660.
(24) Park, et al., Nat. Mater. 2007, 6, 782-789.

1. A method of simultaneously printing at least two different biomolecules on a substrate surface comprising
coating a tip array with at least two inks by dipping the tip array into a corresponding inkwell array having a first plurality of wells comprising a first ink comprising a first biomolecule and a first carrier and a second plurality of wells comprising a second ink comprising a second biomolecule and a second carrier such that a first plurality of tips of the tip array are dipped into the first plurality of wells and coated with the first ink and the second plurality of tips of the tip array are dipped into the second plurality of wells and coated with the second ink,
the tips of the tip array comprising non-cantilevered tips each having a radius of curvature of less than about 1 μm and comprising a compressible elastomeric polymer;
contacting a substrate surface for a first contacting period of time and at a first contacting pressure with all or substantially all of the coated tips of the array to deposit the first ink onto the substrate surface at a set of first positions to form a first set of indicia and the second ink onto the substrate surface at a set of second positions to form a second set of indicia, the all of the indicia of the first and second sets being substantially uniform in size.

2. The method of claim 1, further comprising at least partially filling the first plurality of wells with the first ink and at least partially filling the second plurality of wells with the second ink by jetting droplets of ink into the wells using an inkjet printer.

3. The method of claim 2, wherein the inkjet printer is an electrohydrodynamic inkjet printer.

4. The method of claim 1, wherein all of the indicia of the first and second sets are substantially uniform in ink density.

5. The method of claim 1, wherein the inkwell has inter-well spacings, well dimensions, or both, which correspond to tip apex spacings, tip dimensions, or both, of the tips of the tip array, respectively.

6. The method of claim 1, wherein at least one apex of a tip of the first plurality of tips and at least one apex of a tip of the second plurality of tips are separated by a distance of less than 200 μm.

7. The method of claim 6, wherein an indicium of the first set and an indicium of the second set are separated on the surface by a distance of less than 100 μm.

8. The method of claim 1, wherein the first biomolecule, the second biomolecule, or each of the first biomolecule and the second biomolecule comprises an antibody, antigen, protein, enzyme, peptide, oligonucleotide, polynucleotide, oligosaccharide, polysaccharide, or mixture thereof.

9. The method of claim 1, comprising coating the tip array with no or substantially no contamination of the first ink to the second plurality of tips.

10. The method of claim 1, comprising forming the first set of indicia with no or substantially no contamination of the second ink.

11. The method of claim 1, wherein the first ink, the second ink, or each of the first ink and second ink comprises glycerol, polyethylene glycol, or a mixture thereof.

12. The method of claim 1, wherein at least the well side of the inkwell array comprises a fluorinated surface.

13. The method of claim 12, wherein the fluorinated surface comprises a fluorinated silane.

14. The method of claim 13, wherein the fluorinated silane comprises 1H,1H,2H,2H-perfluorodecyltrichlorsilane.

15. The method of claim 1, comprising forming the first set of indicia, the second set of indicia, or both with a feature size of less than 1 μm.

16. The method of claim 1, wherein the first biomolecule, the second biomolecule, or both further comprise a label.

17. The method of claim 16, wherein the label is a fluorescent label.

18. The method of claim 17, wherein the fluorescent label is selected from the group consisting of a fluorescein dye, 6-((7-amino-4-methylcoumarin-3-acetyl)amino)hexanoic acid, 5(and 6)-carboxy-X-rhodamine, a rhodamine dye, a benzophenoxazine, Cyanine 2 (Cy2) dye, Cyanine 3 (Cy3) dye, Cyanine 3.5 (Cy3.5) dye, Cyanine 5 (Cy5) dye, Cyanine 5.5 (Cy5.5) dye, Cyanine 7 (Cy7) dye, Cyanine 9 (Cy9) dye, 6-carboxy-4′,5′-dichloro-2′,7′-dimethoxyfluorescein, 5(6)-carboxy-tetramethyl rhodamine, and combinations thereof.

19. The method of claim 1, wherein the first biomolecule comprises a first label, and the second biomolecule comprises a second label different from the first label.

20. The method of claim 1, wherein each tip has a radius of curvature of less than about 0.2 μm.

21. The method of claim 1, wherein the compressible elastomeric polymer of the tip array has a compression modulus in a range of about 10 MPa to about 300 MPa.

22. The method of claim 1, wherein the compressible elastomeric polymer comprises polydimethylsiloxane (PMDS).

23. The method of claim 22, wherein the PMDS comprises a trimethylsiloxy terminated vinylmethylsiloxane-dimethysiloxane copolymer, a methylhydrosiloxane-dimethylsiloxane copolymer, or a mixture thereof.

24. The method of claim 1, wherein each tip of the tip array is identically-shaped.

25. The method of claim 24, wherein the tip shape is pyramidal.

26. The method of claim 24, wherein the wells are pyramidal.

27. The method of claim 1, further comprising moving the tip array, the substrate surface, or both, with respect to each other, and repeating the contacting step for a second contacting period of time, same or different from the first contacting period of time and at a second contacting pressure, same or different from the first contacting pressure.

28. The method of claim 1, comprising limiting lateral movement between the tip array and the substrate during the contacting step, to form indicia comprising dots.

29. The method of claim 28, comprising controlling the contacting period of time, the contacting pressure, or both to form the dots with a diameter in a range of about 10 nm to about 500 μm.

30. The method of claim 1, comprising simultaneously contacting each tip of the tip array with the substrate surface.

31. The method of claim 1, wherein the tip array further comprises a third plurality of tips and the inkwell array comprises a third plurality of wells comprising a third ink comprising a third biomolecule and a third carrier, and further comprising coating the third plurality of tips during said dipping step and printing the third biomolecule on the substrate surface during said contacting step, to form a third set of indicia at a set of third positions, wherein all of the indicia of the third set are substantially uniform in size with the first set of indicia and the second set of indicia.

32. The method of claim 31, wherein all of the indicia of the third set are substantially uniform in biomolecule density with the first set of indicia or the second set of indicia.

33. The method of claim 32, wherein all of the indicia of the third set are substantially uniform in biomolecule density with the first set of indicia and the second set of indicia.

34. The method of claim 1, further comprising leveling the tips of the tip array with respect to the substrate surface by
backlighting the tip array with incident light to cause internal reflection of the incident light from the internal surfaces of the tips;
bringing the tips of the tip array and the substrate surface together along a z-axis up to a point of contact between a subset of the tips with the substrate surface, contact indicated by increased intensity of reflected light from the subset of tips in contact with the substrate surface, whereas no change in the intensity of reflected light from other tips indicates non-contacting tips; and
tilting one or both of the tip array and the substrate surface with respect to the other in response to differences in intensity of the reflected light from the internal surfaces of the tips, to achieve contact between the substrate surface and non-contacting tips, wherein said tilting is performed one or more times along x-, y-, and/or z-axes.

35. The method of claim 1, further comprising leveling the tips of the tip array with respect to the substrate surface by
backlighting the tip array with incident light to cause internal reflection of the incident light from the internal surfaces of the tips;
bringing the tips of the tip array and the substrate surface together along a z-axis to cause contact between the tips of the tip array and the substrate surface;
further moving one or both of the tip array and the substrate towards the other along the z-axis to compress a subset of the tips, whereby the intensity of the reflected light from the tips increases as a function of the degree of compression of the tips against the substrate surface; and
tilting one or both of the tip array and the substrate surface with respect to the other in response to differences in intensity of the reflected light from internal surfaces of the tips, to achieve substantially uniform contact between the substrate surface and tips, wherein said tilting is performed one or more times along x-, y- and/or z-axes.

36. The method claim 1, further comprising
forming a master comprising an array of recesses in a substrate separated by lands;
filling the recesses and covering the lands with a prepolymer mixture comprising an prepolymer and, optionally, a crosslinker;
covering the filled and coated substrate with a planar glass layer;
curing the prepolymer mixture to form a polymer structure that comprises the tip array and common substrate;
removing the cured polymer structure from the master; and
at least partially filling the recesses of the master with one or more inks for use as an inkwell array for the tip array.

37. The method of claim 1, further comprising fabricating a mold having recesses and lands; forming a tip array with the mold; removing the formed tip array from the mold; at least partially filling the recesses of the mold with one or more inks to form an inkwell array; and then coating a tip array with said inks by dipping the tip array into the inkwell array.

38. The method of claim 36, further comprising treating at least the surface of the master comprising said recesses and lands with a fluorinated substance.

39. The method of claim 38, comprising carrying out the treating prior to filling the master with a prepolymer mixture.

40. The method of claim 38, comprising carrying out the treating after filling the master with a prepolymer mixture.

41. The method of claim 38, wherein the fluorinated substance comprises 1H,1H,2H,2H-perfluorodecyltrichlorsilane.

42. An article comprising
a substrate;
a first set of indicia on the substrate surface comprising a first biomolecule, and a second set of indicia on the substrate surface comprising a second biomolecule,
wherein all of the indicia of the first set and the second set are substantially uniform in size and an indicium of the first set and an indicium of the second set are separated on the surface by a distance of less than 200 μm.

43. The article of claim 42, wherein all of the indicia of the first set and the second set are substantially uniform in density.

44. The article of claim 42, wherein an indicium of the first set and an indicium of the second set are separated on the surface by a distance of less than 100 μm.

45. The method of claim 42, wherein all of the indicia of the first and second sets have a feature size of less than 100 μm.

46. The article of claim 42, wherein the first biomolecule, the second biomolecule, or each of the first biomolecule and the second biomolecule comprises an antibody, antigen, protein, enzyme, peptide, oligonucleotide, polynucleotide, oligosaccharide, polysaccharide, or mixture thereof.

47. The article of claim 42, further comprising a third set of indicia on the substrate surface comprising a third biomolecule, wherein all of the indicia of the third and all of the indicia of the first set are substantially uniform in size.

48. The article of claim 47, wherein all of the indicia of the third set and all of the indicia of the first set are substantially uniform in density.
